(19) United States
(12) Patent Application Publication
(10) Pub. No.: US 2025/0131023 A1
(43) Pub. Date: Apr. 24, 2025

(54) User's Attention Based Context Weighting And Selection For Prompting Large Generative AI Models

(71) Applicant: QUALCOMM Incorporated, San Diego, CA (US)

(72) Inventors: Kyuhong SHIM, Seoul (KR); Jaeseong YOU, Seoul (KR); Sunghyun PARK, Seoul (KR); Geunho LEE, Seoul (KR); Michael Franco TAVEIRA, San Diego, CA (US)

(21) Appl. No.: 18/492,360

(22) Filed: Oct. 23, 2023

(51) Int. Cl. G06F 16/33; G06F 3/01; G06F 3/041; G06F 16/335; G06F 16/34

(52) U.S. Cl. CPC G06F 16/3344; G06F 3/013; G06F 3/0412; G06F 16/3334; G06F 16/335; G06F 16/345

(57) ABSTRACT

Various embodiments include systems and methods for generating a prompt for a large generative AI model (LXM), such as a large language model (LLM), large speech model (LSM), large/language vision model (LVM), vision language models (VLMs), hybrid model, multi-modal model, etc. A computing device may be equipped with components configured to receive a user's prompt for the LXM, determine a user's attention to the subject matter at the time or prior to receipt of the user's prompt, generate an enhanced prompt based on the user's prompt and the subject matter to which the user is paying attention at the time or prior to receipt of the user's prompt, and submit the enhanced prompt to the LLM.

### BACKGROUND

Recent advancements in artificial intelligence (AI) and machine learning (ML) technologies have led to the development of increasingly sophisticated models capable of understanding and interpreting complex data structures. These models, commonly known as large generative AI models (LXMs), have a multitude of applications that span across various domains, from natural language processing to computer vision and speech recognition. Their efficacy stems from their ability to learn from massive datasets, gaining an unprecedented depth of understanding and applicability.

The increasing capabilities of LXMs, including (but not limited to) Large Language Models (LLMs), Large Speech Models (LSMs), and Large Vision Models (LVMs) (which are also referred to as Language Vision Models or Vision Language Models (VLMs)), offer enhanced functionality in various applications such as natural language understanding, speech recognition, visual analysis, text generation, speech generation, image generation, and/or the like. Among the diverse types of LXMs, LLMs are generally known for their capabilities in understanding and generating human language. These models may be trained on extensive textual datasets and may perform such tasks as machine translation, text summarization, question-answering, and/or the like. LLMs have found applications in a broad range of industries including healthcare, finance, and customer service, among others.

An LSM is a type of LXM specializing in processing and understanding auditory data. LSMs may translate spoken language into textual form and vice versa. LSMs excel at tasks such as speech-to-text conversion, voice recognition, natural language understanding within a spoken context, providing spoken word responses in machine-generated voices, and/or the like. The efficacy of LSMs lies in their capacity to learn from enormous datasets containing diverse accents, dialects, and languages.

An LVM is a LXM that is trained to interpret and analyze visual data. LVM models may use convolutional neural networks or similar architectures to process visual inputs and derive meaningful conclusions from them. From image classification to object detection and generating new images in response to natural language prompts, LVMs are growing in popularity and use in diverse areas such as medical imaging, autonomous vehicles, surveillance systems, advertising, and entertainment.

### SUMMARY

Various aspects include methods performed by a computing device for generating a prompt for a large generative AI model (LXM), which may include receiving a user's prompt for the LXM, determining a user's attention to subject matter at the time or prior to receipt of the user's prompt, generating an enhanced prompt based on the user's prompt and the subject matter to which the user is paying attention at the time or prior to receipt of the user's prompt, and submitting the enhanced prompt to the LXM.

In some aspects, generating the enhanced prompt based on the user's prompt and the subject matter to which the user is paying attention may include applying an adaptive important weighting to portions of the user's prompt based on the user's attention to the subject matter at the time or prior to receipt of the user's prompt.

In some aspects, determining a user's attention to the subject matter may include one or more of tracking the user's eye gaze on the subject matter, tracking a mouse cursor location on the subject matter, or tracking the user's touch locations on the subject matter.

In some aspects, generating the enhanced prompt may include generating a summary prompt that includes words assigned greater weight based on the user's attention to the subject matter at the time or prior to receipt of the user's prompt.

In some aspects, applying an adaptive important weighting to portions of the user's prompt based on the user's attention to the subject matter at the time or prior to receipt of the user's prompt may include adding an attention bias weight to words in the user's prompt based observations of the user's attention paid to words or phrases in the subject matter prior to entry of the user's prompt. Some aspects may further include increasing the attention bias weight responsive to a duration the user focused on particular words and decreasing the attention bias weight with time after the user focus shifts away from the particular words. In some aspects, an amount by which the attention bias weight is increased responsive to the duration the user focused on the particular words and decreases with time after the user focus shifts away from the particular words depends on one or more of a type of word, a relevance of the words to the user's prompt, or a uniqueness of the words.

In some aspects, generating the enhanced prompt based on the user's prompt and the subject matter to which the user is paying attention may include including in the enhanced prompt information regarding the subject matter to which the user paid attention to at the time or prior to receipt of the user's prompt. In some aspects, including in the enhanced prompt information regarding the subject matter to which the user paid attention to at the time or prior to receipt of the user's prompt may include generating text describing a portion of the subject matter to which the user paid attention to at the time or prior to receipt of the user's prompt, and including at least a portion of the generated text in the enhanced prompt. In some aspects, including in the enhanced prompt information regarding the subject matter to which the user paid attention to at the time or prior to receipt of the user's prompt may include generating text summarizing the subject matter to which the user paid attention to at the time or prior to receipt of the user's prompt, and including at least a portion of the generated text in the enhanced prompt.

In some aspects, determining the user's attention to the subject matter at the time or prior to receipt of the user's prompt may include determining the user's attention to subject matter associated with the computing device at the time or prior to receipt of the user's prompt. In some aspects, determining the user's attention to the subject matter at the time or prior to receipt of the user's prompt may include determining the user's attention to subject matter associated with another nearby device at the time or prior to receipt of the user's prompt.

In some aspects, receiving the user's prompt for the LXM may include receiving the user's prompt for a large language model (LLM), and submitting the enhanced prompt to the LXM may include submitting the enhanced prompt to the LLM.

In some aspects, determining the user's attention to the subject matter at the time or prior to receipt of the user's prompt may include determining the user's attention to subject matter presented on a display of the computing device at the time or prior to receipt of the user's prompt, and generating the enhanced prompt based on the user's prompt and the subject matter to which the user may be paying attention at the time or prior to receipt of the user's prompt may include generating the enhanced prompt based on the user's prompt and subject matter presented on the display to which the user may be paying attention at the time or prior to receipt of the user's prompt, Further aspects may include a computing device having a processor configured with processor-executable instructions to perform various operations corresponding to the methods discussed above.

Further aspects may include a computing device having a processing system configured with processor-executable instructions to perform various operations corresponding to the methods summarized above. Further aspects may include a non-transitory processor-readable storage medium having stored thereon processor-executable instructions configured to cause a processing system to perform various operations corresponding to the method operations summarized above. Further aspects may include a computing device having various means for performing functions corresponding to the method operations summarized above.

### BRIEF DESCRIPTION OF THE DRAWINGS

The accompanying drawings, which are incorporated herein and constitute part of this specification, illustrate exemplary embodiments of the claims, and together with the general description given and the detailed description, serve to explain the features herein.

FIG. 1 is a component block diagram illustrating example components in a system in package (SIP) that may be included in a computing device and configured to implement some embodiments.

FIG. 2 is a component block diagram illustrating example components and operations in a system configured to implement some embodiments.

FIGS. 3 and 4 are process flow diagrams illustrating methods of adaptively managing user prompts to improve output from a generative AI model based on the user's current focus or interests in accordance with some embodiments.

FIG. 5 is a component block diagram illustrating an example computing device in the form of a laptop that is suitable for implementing some embodiments.

FIG. 6 is a component block diagram illustrating an example wireless communication device suitable for use with various embodiments.

FIG. 7 is a component diagram of an example server suitable for implementing some embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments include methods, and computing devices configured to implement the methods, of generating a prompt for a large generative AI model (LXM), such as a large language model (LLM), large speech model (LSMs), large/language vision model (LVM), hybrid model, multi-modal model, etc. A computing device may be equipped with components configured to receive a user's prompt for the LXM and determine a user's attention to the subject matter displayed on the computing device at the time or prior to receipt of the user's prompt. In some embodiments, the computing device may determine the level of the user's attention towards content displayed on the computing device based on tracking eye gaze, mouse cursor location, or touch input on the displayed content. The computing device may generate an enhanced prompt based on the user's prompt and the subject matter displayed on the computing device to which the user is paying attention at the time or prior to receipt of the user's prompt and submit the enhanced prompt to the LLM.

In some embodiments, the computing device may use measures of the user's attention to generate an enhanced prompt that integrates the original user prompt and the content displayed on the device to which the user directed attention. In some embodiments, the computing device may use eye tracking to identify the word, sentence, or paragraph the user is looking at when speaking an otherwise indefinite prompt. By tracking where the user is looking on a display page of text and other measures of the user's current attention, the components can recognize what the user is referring to, add that information to a generated prompt, and thereby provide to the LXM all the information needed for the model to provide a satisfying response without requiring the user to say or write a long prompt. In some embodiments, the computing device may generate the enhanced prompt to include details related to the content displayed on the device that had caught the user's attention at the time or prior to the prompt.

In some embodiments, the computing device may generate a summary prompt that includes terms that are given greater weight based on the user's attention metrics. In some embodiments, the computing device may generate the enhanced prompt to include a textual summary of the subject matter displayed on the device that had caught the user's attention.

In some embodiments, the computing device may apply adaptive weights to segments of the original prompt based on the user's attention levels. For example, the computing device may assign an attention bias weight to terms in the original prompt that may be influenced by the user's focus on those terms in the displayed content, etc. In some embodiments, the computing device may adjust the attention bias weight based on the duration of the user's focus on particular terms (which could decay over time as the user's focus shifts).

By generating adaptive prompts that align with the user's current or recent attention levels and combining the user's original prompt with dynamically weighted terms and relevant subject matter, various embodiments may improve or optimize the output from LXMs. The embodiments may improve the performance and functionality of the computing device by offering users a more tailored and efficient user experience that improves the user experience without having a significant negative impact on the performance or power consumption characteristics of the computing device.

The term “computing device” is used herein to refer to (but not limited to) any one or all of personal computing devices, personal computers, workstations, laptop computers, Netbooks, Ultrabook, tablet computers, mobile communication devices, smartphones, user equipment (UE), personal data assistants (PDAs), palm-top computers, wireless electronic mail receivers, multimedia internet-enabled cellular telephones, media and entertainment systems, gaming systems (e.g., PlayStation™, Xbox™, Nintendo Switch™), media players (e.g., DVD players, Roku™, apple TV™), digital video recorders (DVRs), portable projectors, 3D holographic displays, wearable devices (e.g., earbuds, smartwatches, fitness trackers, augmented reality (AR) glasses, head-mounted displays, etc.), vehicle systems such as drones, automobiles, motorcycles, connected vehicles, electric vehicles, automotive displays, advanced driver-assistance systems (ADAS), etc., cameras (e.g., surveillance cameras, embedded cameras), smart devices (e.g., smart light bulbs, smartwatches, thermostats, smart glasses, etc.), Internet of Things (IoT) devices, other similar devices that include a programmable processing system that may be configured to provide the functionality of various embodiments.

The term “processing system” is used herein to refer to one more processors, including multi-core processors, that are organized and configured to perform various computing functions. Various embodiment methods may be implemented in one or more of multiple processors within a processing system as described herein.

The term “system on chip” (SoC) is used herein to refer to a single integrated circuit (IC) chip that contains multiple resources or independent processors integrated on a single substrate. A single SoC may contain circuitry for digital, analog, mixed-signal, and radio-frequency functions. A single SoC may include a processing system that includes any number of general-purpose or specialized processors (e.g., network processors, digital signal processors, modem processors, video processors, etc.), memory blocks (e.g., ROM, RAM, Flash, etc.), and resources (e.g., timers, voltage regulators, oscillators, etc.). For example, an SoC may include an applications processor that operates as the SoC's main processor, central processing unit (CPU), microprocessor unit (MPU), arithmetic logic unit (ALU), etc. An SoC processing system also may include software for controlling integrated resources and processors, as well as for controlling peripheral devices.

The term “system in a package” (SIP) is used herein to refer to a single module or package that contains multiple resources, computational units, cores, or processors on two or more IC chips, substrates, or SoCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high-speed communication circuitry and packaged in close proximity, such as on a single motherboard, in a single UE, or in a single CPU device. The proximity of the SoCs facilitates high-speed communications and the sharing of memory and resources.

The term “neural network” is used herein to refer to an interconnected group of processing nodes (or neuron models) that collectively operate as a software application or process that controls a function of a computing device and/or generates an overall inference result as output. Individual nodes in a neural network may attempt to emulate biological neurons by receiving input data, performing simple operations on the input data to generate output data, and passing the output data (also called “activation”) to the next node in the network. Each node may be associated with a weight value that defines or governs the relationship between input data and output data. A neural network may learn to perform new tasks over time by adjusting these weight values. In some cases, the overall structure of the neural network and/or the operations of the processing nodes do not change as the neural network learns a task. Rather, learning is accomplished during a “training” process in which the values of the weights in each layer are determined. As an example, the training process may include causing the neural network to process a task for which an expected/desired output is known, comparing the activations generated by the neural network to the expected/desired output, and determining the values of the weights in each layer based on the comparison results. After the training process is complete, the neural network may begin “inference” to process a new task with the determined weights.

The term “inference” is used herein to refer to a process that is performed at runtime or during the execution of the software application program corresponding to the neural network. Inference may include traversing the processing nodes in the neural network along a forward path to produce one or more values as an overall activation or overall “inference result.”

Deep neural networks implement a layered architecture in which the activation of a first layer of nodes becomes an input to a second layer of nodes, the activation of a second layer of nodes becomes an input to a third layer of nodes, and so on. As such, computations in a deep neural network may be distributed over a population of processing nodes that make up a computational chain. Deep neural networks may also include activation functions and sub-functions (e.g., a rectified linear unit that cuts off activations below zero, etc.) between the layers. The first layer of nodes of a deep neural network may be referred to as an input layer. The final layer of nodes may be referred to as an output layer. The layers in-between the input and final layer may be referred to as intermediate layers, hidden layers, or black-box layers.

Each layer in a neural network may have multiple inputs and thus multiple previous or preceding layers. Said another way, multiple layers may feed into a single layer. For ease of reference, some of the embodiments are described with reference to a single input or single preceding layer. However, it should be understood that the operations disclosed and described in this application may be applied to each of multiple inputs to a layer and multiple preceding layers.

The term “recurrent neural network” (RNN) is used herein to refer to a class of neural networks particularly well-suited for sequence data processing. Unlike feedforward neural networks, RNNs may include cycles or loops within the network that allow information to persist. This enables RNNs to maintain a “memory” of previous inputs in the sequence, which may be beneficial for tasks in which temporal dynamics and the context in which data appears are relevant.

The term “long short-term memory network” (LSTM) is used herein to refer to a specific type of RNN that addresses some of the limitations of basic RNNs, particularly the vanishing gradient problem. LSTMs include a more complex recurrent unit that allows for the easier flow of gradients during backpropagation. This facilitates the model's ability to learn from long sequences and remember over extended periods, making it apt for tasks such as language modeling, machine translation, and other sequence-to-sequence tasks.

The term “transformer” is used herein to refer to a specific type of neural network that includes an encoder and/or a decoder and is particularly well-suited for sequence data processing. Transformers may use multiple self-attention components to process input data in parallel rather than sequentially. The self-attention components may be configured to weigh different parts of an input sequence when producing an output sequence. Unlike solutions that focus on the relationship between elements in two different sequences, self-attention components may operate on a single input sequence. The self-attention components may compute a weighted sum of all positions in the input sequence for each position, which may allow the model to consider other parts of the sequence when encoding each element. This may offer advantages in tasks that benefit from understanding the contextual relationships between elements in a sequence, such as sentence completion, translation, and summarization. The weights may be learned during the training phase, allowing the model to focus on the most contextually relevant parts of the input for the task at hand. Transformers, with their specialized architecture for handling sequence data and their capacity for parallel computation, often serve as foundational elements in constructing large generative AI models (LXM).

The term “large generative AI model” (LXM) is used herein to refer to an advanced computational framework that includes any of a variety of specialized AI models including, but not limited to, large language models (LLMs), large speech models (LSMs), large/language vision models (LVMs), vision language models (VLMs)), hybrid models, and multi-modal models. An LXM may include multiple layers of neural networks (e.g., RNN, LSTM, transformer, etc.) with millions or billions of parameters. Unlike traditional systems that translate user prompts into a series of correlated files or web pages for navigation, LXMs support dialogic interactions and encapsulate expansive knowledge in an internal structure. As a result, rather than merely serving a list of relevant websites, LXMs are capable of providing direct answers and/or are otherwise adept at various tasks, such as text summarization, translation, complex question-answering, conversational agents, etc. In various embodiments, LXMs may operate independently as standalone units, may be integrated into more comprehensive systems and/or into other computational units (e.g., those found in a SoC or SIP, etc.), and/or may interface with specialized hardware accelerators to improve performance metrics such as latency and throughput. In some embodiments, the LXM component may be enhanced with or configured to perform an adaptive algorithm that allows the LXM to better understand context information and dynamic user behavior. In some embodiments, the adaptive algorithms may be performed by the same processing system that manages the core functionality of the LXM and/or may be distributed across multiple independent processing systems.

The term “enhanced prompt” is used herein to refer to a prompt that is generated for submission to an LXM based upon a received user prompt but with additional information, such as context information, user focus information, word, or subject matter focus information, and/or the like as described herein. In some cases, an enhanced prompt may be shorter than the received user prompt, such as when the generated prompt summarizes the user's intent or removes or replaces words or phrases for prompting the LXM, such as to reduce a token count in the prompt.

The term “embedding layer” is used herein to refer to a specialized layer within a neural network, typically at the input stage, that transforms discrete categorical values or tokens into continuous, high-dimensional vectors. An embedding layer may operate as a lookup table in which each unique token or category is mapped to a point in a continuous vector space. The vectors may be refined during the model's training phase to encapsulate the characteristics or attributes of the tokens in a manner that is conducive to the tasks the model is configured to perform.

The term “token” is used herein to refer to a unit of information that an LXM may read as a single input during training and inference. Each token may represent any of a variety of different data types. For example, in text-centric models such as in LLMs, each token may represent a one or more textual element such as a paragraph(s), sentence(s), clause(s), word(s), sub-word(s), character(s), etc. In models designed for auditory data, such as LSMs, each token may represent a feature extracted from audio signals, such as a phoneme, spectrogram, temporal dependency, Mel-frequency cepstral coefficients (MFCCs) that represent small segments of an audio waveform, etc. In visual models such as LVM, each token may correspond to a portion of an image (e.g., pixel blocks), sequences of video frames, etc. In hybrid systems that combine multiple modalities (text, speech, vision, etc.), each token may be a complex data structure that encapsulates information from various sources. For example, a token may include both textual and visual information, each of which independently contributes to the token's overall representation in the model.

There are generally limitations on the total number of tokens that may be processed by AI models. As an example, a model with a limitation of 512 tokens may alter or truncate input sequences that go beyond this specific count.

Each token may be converted into a numerical vector via the embedding layer. Each vector component (e.g., numerical value, parameter, etc.) may encode an attribute, quality, or characteristic of the original token. The vector components may be adjustable parameters that are iteratively refined during the model training phase to improve the model's performance during subsequent operational phases. The numerical vectors may be high-dimensional space vectors (e.g., containing more than 300 dimensions, etc.) in which each dimension in the vector captures a unique attribute, quality, or characteristic of the token. For example, dimension 1 of the numerical vector may encode the frequency of a word's occurrence in a corpus of data, dimension 2 may represent the pitch or intensity of the sound of the word at its utterance, dimension 3 may represent the sentiment value of the word, etc. Such intricate representation in high-dimensional space may help the LXM understand the semantic and syntactic subtleties of its inputs. During the operational phase, the tokens may be processed sequentially through layers of the LXM or neural network, which may include structures or networks appropriate for sequence data processing, such as transformer architectures, recurrent neural networks (RNNs), or long short-term memory networks (LSTMs).

The term “sequence data processing” is used herein to refer to techniques or technologies for handling ordered sets of tokens in a manner that preserves their original sequential relationships and captures dependencies between various elements within the sequence. The resulting output may be a probabilistic distribution or a set of probability values, each corresponding to a “possible succeeding token” in the existing sequence. For example, in text completion tasks, the LXM may suggest the possible succeeding token determined to have the highest probability of completing the text sequence. For text generation tasks, the LXM may choose the token with the highest determined probability value to augment the existing sequence, which may subsequently be fed back into the model for further text production.

The term “attention-based metrics” (ABM) is used herein to refer to data units or information structures that quantify, measure, or otherwise characterize various facets of user attention, user engagement, user focal point, user area of interest, etc. ABMs may be derived based on various techniques, factors, conditions and/or data sources, including, but not limited to, eye gaze tracking or focus levels measured through eye-tracking technologies, mouse cursor positioning, mouse movements, time on task (e.g., time spent on specific tasks), touch input, keyboard activity, scroll behavior, page focus events, application usage, audio cues, facial recognition, biometric data, device sensors, environmental sensors, proximity sensors, machine learning algorithms, real-time user behavior, ongoing workflow, prevailing interests, historical data, user profiles, task complexity, user feedback, calendar data, sentiment analysis, browser tabs, system notifications, anomaly detection, multi-device behavior, social interactions, etc. ABMs may be used in real time or may be aggregated over time to provide a longitudinal view of user behavior and focus. In some embodiments, the ABMs may serve to inform and adapt the functionality of other systems, such as LXMs, SoCs, etc. The ABMs may be generated and analyzed by a single computational unit within a processing system or may result from collaborative computations across multiple independent processing systems. The ABMs may be stored in on-board memory blocks or off-site data storage solutions, subjected to further analysis to refine their accuracy or utility, and/or incorporated into adaptive algorithms to improve system performance, improve the user experience, guide the operation of specialized hardware or software components, etc.

The term “attention tracking” is used herein to refer to operations performed in the computing device for monitoring and recording various metrics (e.g., ABMs, etc.) suitable for determining dimensions of user interaction and focus, such as user attention, user engagement, user focal point, and/or user area of interest within a digital environment. In some embodiments, the computing device may be configured to implement and use various attention-tracking techniques and technologies to collect, generate, and/or analyze ABMs in real-time or near-real-time, use the ABMs or analysis results to control or alter the output of LXMs so that they better align with the user's immediate needs (or long-term preferences, current area of focus, etc.). In some embodiments, hardware or software elements specializing in attention-tracking activities might be incorporated into the computing device, function as distinct peripheral units, or operate under the governance of the same computing system that oversees the core operations of the LXM. Alternatively, these functions may be distributed across several independent processing systems.

The term “word-level attention scores” is used herein to describe quantifiable values that may indicate the degree of importance or relevance assigned to individual tokens or words within a text sequence during the processing stages of AI models, such as LXMs. These word-level attention scores may be derived from various algorithms or models specialized in attention mechanisms including, but not limited to, self-attention algorithms. Word-level attention scores may serve to highlight the words in a sequence that contribute more meaningfully to the output of the model, whether it be in tasks related to text summarization, translation, question-answering, or any other application involving sequence data processing. In text-based AI models, these attention scores may directly affect the weighting of each word in the input sequence when calculating the model's output. In auditory models, similar attention scores may be applied to audio features like phonemes or MFCCs. In visual models, the equivalent of word-level attention scores may be adapted to focus on regions or components within an image. In various embodiments, word-level attention scores may be used in combination with other metrics, such as ABMs, to enhance the functionality of LXMs, or they may be utilized in analysis tools to provide insights into model behavior or decision-making processes. Like ABMs, word-level attention scores may be calculated and managed by a single computational unit or distributed across multiple independent processing systems for enhanced performance or analysis capabilities.

Despite their robust capabilities, there are a number of technical challenges associated with using conventional LXMs, including limited adaptivity and extensive prompt lengths. For example, there are various well-known technical challenges associated with crafting, shaping, or fine-tuning text prompts (commonly referred to as “prompting” or “prompt engineering”) to obtain relevant and accurate output from an LXM. This is because many conventional LXM systems rely solely or heavily on their initial text prompts without incorporating real-time user attention or interest metrics (e.g., ABMs, etc.) to determine context or refine the user prompts. Conventional LXM solutions also do not adapt dynamically to shifts in user behavior or preferences and require text prompts that are laden with extensive contextual information, which may lead to lengthiness or overly extended prompts that could have a negative impact on the user experience, system responsiveness, device latency, and energy consumption characteristics of the device. Some embodiments may include components configured to mitigate these and other limitations of conventional LXM-based systems by reducing or minimizing prompt length, increasing contextual sensitivity in the input data, and/or otherwise allowing the LXM to produce outputs that are more finely attuned to the user's current behavior, interests, engagement, focus, or needs.

The performance and efficacy of an LXM system may depend on the quality and relevance of the context of the input, which is often a textual prompt that ranges from 4,000 to 500,000 tokens (or more). Aligning the textual prompt with the user's ongoing behavior or interests is a considerable technical challenge that may directly affect the relevance and accuracy of the LXM output. In addition, the length of the textual prompts (e.g., 4,000 to 500,000 tokens) may require considerable computational resources and/or may otherwise have a significant negative impact on the performance and energy consumption characteristics of the computing device.

Various embodiments include computing devices equipped with components that are configured to mitigate these and other technical challenges to improve the performance and efficacy of the LXM system. Embodiment components may improve the quality, caliber, pertinence, and/or relevance of the input context, align the textual prompts more closely with the user's current behavior or interests, and/or reduce the length of the textual prompts without reducing their relevance and/or without having a significant negative or user perceivable impact on the performance or energy consumption characteristics of the computing device.

Some embodiments may include computing systems equipped with components configured to receive a user prompt for the LXM, perform attention-tracking operations to determine ABMs, use the determined ABMs to generate contextual information for the received user prompt, and generate contextual tokens relevant to the received user prompt and/or tokenize the contextual information, ABMs and/or received user prompt. The components may determine and assign weighs to the contextual tokens based on the probability or likelihood of the information enhancing the output of the LXM, use the weighted contextual tokens to construct a refined or enhanced prompt that merges, augments, or amalgamates the original user prompt tokens with the weighted contextual tokens or the subject matter to which the user is currently attentive, send the generated enhanced prompt to the LXM. In response, the computing device may receive a response from the LXM that is more closely aligned with the user's current behavior or interests and/or that is of higher quality, caliber, pertinence, and/or relevance.

In various embodiments, the components may be configured to generate the enhanced prompt to include any of a variety of different types of information. For example, the components may generate the enhanced prompt to integrate the original user prompt tokens with the weighted contextual tokens, to include tokens representing content that has garnered the user's focus, to include tokens associated with the specific subject matter that is currently engaging the user's attention, to integrate original user prompt with generated contextual information, to include content that has captured the user's focus, to include details related to the specific subject matter that has caught the user's focus, to include attention metrics (e.g., ABMs, etc.), to include a summary that places greater emphasis on terms or concepts determined based on the attention metrics, to include a textual summary of the most engaging subject matter, etc. In some embodiments, the components may be configured to generate the enhanced prompt so that it is shorter or includes fewer words or tokens than the received user prompt.

In some embodiments, the components may be configured to condense large textual prompts based on the ABMs and/or summarize prompts into shorter versions that retain the key elements of user interest to reduce the computational burdens associated with handling long context lengths and/or to otherwise improve the performance and power consumption characteristics of the computing device.

In some embodiments, the components may be configured to reduce or eliminate non-adaptive textual prompts that are not consistent with the ABMs (e.g., prompts that do not align with the user's current behavior or interests, etc.).

In some embodiments, the components may be configured to apply variable weighting that is influenced by the current focus/attention levels of the user to segments of the original received user prompt or to segments of the original user prompt tokens. For example, the components may assign attention bias weights to original user prompt tokens based on the user's focus on the terms represented by the original user prompt tokens and dynamically adjust the weights (e.g., reduce or diminish a weight value in response to detecting a shift in the user's focus, increase the weight value in response to detecting a heightened focus on the terms represented by particular tokens, etc.). By using adaptive prompts that adequately account for the user's current or recent focus, and by dynamically adjusting the weights of tokens in the prompts, the components may improve the user experience without adversely impacting the device's performance or power consumption characteristics.

In some embodiments, the components may be configured to determine a user's current, recent, or latest areas of interest or focus, generate context information based on the determined user interest/focus, and use the generated context information to adaptively update the input provided to the LXMs. In some embodiments, the components may be configured to dynamically adjust the context information provided to LXMs (e.g., by applying attention-based context weighting and selection, etc.) to further improve the quality of the output generated by the LXMs. In some embodiments, the components may be configured to use external information sources to augment the context information and allow the user to receive outputs that are highly contextualized without having to divert attention from their ongoing tasks.

In some embodiments, the components may be configured to perform visual interpretation operations, such as responding to a user saying, “What does this mean?,” “Illustrate the current paragraph for my child.”, or “Find a similar picture for the current page.” while reading a fairy tale. In some embodiments, the components may be configured to use the paragraph that was recently read as a flexible prompt to guide a Text-to-Image model. In some embodiments, the components may be configured to use eye tracking to identify the word, sentence, or paragraph the user is looking at when speaking an otherwise indefinite prompt. By tracking where the user is looking on a display page of text and other measures of the user's current attention, the components can recognize what the user is referring to, add that information to a generated prompt, and thereby provide to the LXM all the information needed for the model to provide a satisfying response without requiring the user to say or write a long prompt. In this manner, tracking the user's attention may improve the user experience by making use of the LXM easier and more responsive to the user's intent.

In some embodiments, the components may be configured to perform time-sensitive summarization operations, such as responding to a user saying “summarize this paragraph” or saying “summarize the previous story” while reading a lengthy document. In some embodiments, the components may be configured to tailor these summaries so that the generated prompt takes into consideration elements that the user may have missed or overlooked (or topics that engaged the user for an extended period, etc.).

In some embodiments, the components may be configured to perform recall assistance operations, such as in response to a user saying “please tell me more about the sentence was I looking at two minutes ago?”

In some embodiments, the components may be configured to perform enhanced speech recognition operations, such as for automatic speech recognition (ASR). For example, the components may bias the model towards recently observed unique terms, proper nouns, names, abbreviations, etc. in the current document so that the output generated LXM is more closely aligned with the user's current focus.

In some embodiments, the components may be configured to integrate a scoring algorithm for each token or word in the textual content based on the ABMs. Each token or word may be assigned a dynamically modifiable score and decay rate. For example, the components may assign words with frequent appearances but low informational value (e.g., “a”, “the”, etc.) a lower initial score and a higher decay rate.

In some embodiments, the components may be configured to increment the scores (or use bonus scores) associated with tokens or words when they are revisited by the user or when they align with the original user prompt (or user query). The components may decrease the decay rate for these tokens or words so that they are more likely to be included in subsequent operations, such as summarization or contextual embedding.

In some embodiments, the components may be configured to apply variable weightings influenced by real-time ABMs, not merely to segments of the original prompt, but also to specific terms within those segments. For example, the components may assign higher weights to terms that are included in the displayed content on which the user focuses his attention or gaze.

In some embodiments, the components may be configured to implement a scoring algorithm that uses exponential decay functions to model how the attention given to each token or word changes over time and/or to more finely tune or adapt to the temporal dynamics of user attention.

In some embodiments, the components may be configured to perform attention-based summarizations that prioritize specific segments the user may have missed. By prioritizing the segments that the user may have missed, the components may allow the LXM to generate more relevant and useful summaries, such as when the user requests “summarize the previous story” after an extended period of inactivity or distraction.

In some embodiments, the components may be configured to work in conjunction with, for example, visual or auditory data models (or other data models) for enhanced output generation. For example, when coupled with a Text-to-Image model, the components may use the weights and/or tokens to steer the LXM toward generating images that are highly relevant to the user's current focus in a document. As another example, when linked with automatic speech recognition (ASR) systems, the components may use the weights and/or tokens to steer the LXM toward generating transcriptions that are more accurate and contextually relevant.

In some embodiments, the components may be configured to integrate the individual token/word scores deeply into the internal workings of the attention mechanisms. For example, the score associated with each token or word may serve as an additional term within a transformer layer that utilizes self-attention mechanisms. This augmentation of the self-attention computation may allow for a more nuanced representation of the content and improve the quality of the generated output.

In some embodiments, the components may be configured to convert multimodal context into attention scores for individual words and/or generate word-level attention scores. The components may use the features and capabilities of the local computing device (e.g., mobile device, etc.) to capture user attention data and/or generate the ABMs.

In some embodiments, the components may be configured to provide dynamic control of word attention through a control mechanism that adapts to both user behavior and existing LXM scores. The dynamic nature of these scores may allow the components to routinely and automatically decrease or depreciate the scores over time (e.g., based on a decay rate, etc.). On the other hand, if a user focuses more on a given word, the components may increase its associated scores and/or sustain the scores for a longer duration.

In some embodiments, the components may be configured to apply a slower decay rate to token/word scores that are deemed to be unique, noteworthy, important, or otherwise notable. By applying a slower decay rate, these tokens/words are more likely to be included in subsequent operations and enhance the relevance and contextual relevance of the output generated by the LXM.

In some embodiments, the components may be configured to modify or update the word-level scores based on their relevance to the original user prompt or the user's query. For example, the components may increase a score associated with a token or word and/or decrease an associated decay rate in response to determining that the score is consistent with or in alignment with the LXM's understanding of the importance of that token/word. Such adjustments may allow for modifications to model attention mechanisms and for the LXM to generate more accurate model predictions and more relevant outputs.

In some embodiments, the components may be configured to use word-level attention scores for context compression. For example, the components use the word-level attention scores to produce a condensed representation of the context information without sacrificing the quality or relevance of the information.

In some embodiments, the components may be configured to detect variances in contextualized output given the same query but different temporal contexts. In some embodiments, the components may be configured to request, provide, and/or receive differing levels of contextual information. For example, the components may adjust the level of contextual information (e.g., based on internal algorithms, etc.) in response to determining that the original user prompt includes information that is not discernable without a preceding context (e.g., within a period of two to five minutes, etc.).

In some embodiments, the components may be configured to convert existing workflow information into text and use the converted text as a backdrop for more advanced operations. For example, in systems or for prompts in which visual or attention-related cues are determined to be particularly important, the components may automatically assign differing importance levels or “scores” to individual words and/or modify assigned scores based on the user's attention data or ABMs. The components may use the assigned scores to determine the overall relevance between a term included in the original user prompt and the existing text and generate the enhanced prompt to account for the determined overall relevance of the terms.

In some embodiments, the components may be configured to use word-level attention scores to streamline text. In such embodiments, the components may be configured to reduce the length of the text prompt by prioritizing or focusing on the terms that are associated with higher attention scores.

As discussed above, attention-based metrics (ABM) may be data units or information structures that quantify, measure, or otherwise characterize various facets of user attention, user engagement, user focal point, user area of interest, etc. In various embodiments, the components may be configured to condense large textual prompts based on the ABMs, reduce or eliminate non-adaptive textual prompts that are not consistent with the ABMs, integrate a scoring algorithm for each token or word in the textual content based on the ABMs, apply variable weightings influenced by real-time ABMs, use the features and capabilities of the local computing device to generate ABMs, etc.

In various embodiments, the components may determine the ABMs based on various techniques and/or factors, including gaze tracking or focus determinations via eye-tracking systems, cursor placement or motion, task duration, tactile interactions, keyboard use, scrolling actions, application engagement, auditory indicators, facial analytics, biometric metrics, sensor readings from the device or environment, proximal sensor data, algorithmic learning models, real-time user actions, current workflow, existing preferences, past interactions, user-specific data, intricacy of tasks, feedback from users, schedule information, mood analysis, web browsing details, system alerts, atypical activity detection, multi-gadget usage, and social engagement.

As some nonlimiting examples, the components may determine the ABMs by assessing the user's concentration, attentiveness, and/or engagement with the computing system. This assessment may be informed by patterns and frequency of key presses, auditory input capturing verbal expressions and instructions, ocular movements, facial expressions approximating emotional conditions, user proximity to a display, physiological indicators like heart rate or skin conductance, ambient conditions like lighting or temperature known to affect focus, cognitive load inferred from the complexity of viewed material, scrolling behavior and pauses that reflect content engagement, usage patterns of software or online platforms, task or application engagement durations highlighting focus or inattention, past user interactions (e.g., commonly accessed websites or applications, etc.), information in the user's demographic or professional profile, communication habits through different platforms, consolidated metrics from various devices (e.g., smartphones and wearables, etc.) that offer a more comprehensive view of the user's level of attention, etc.

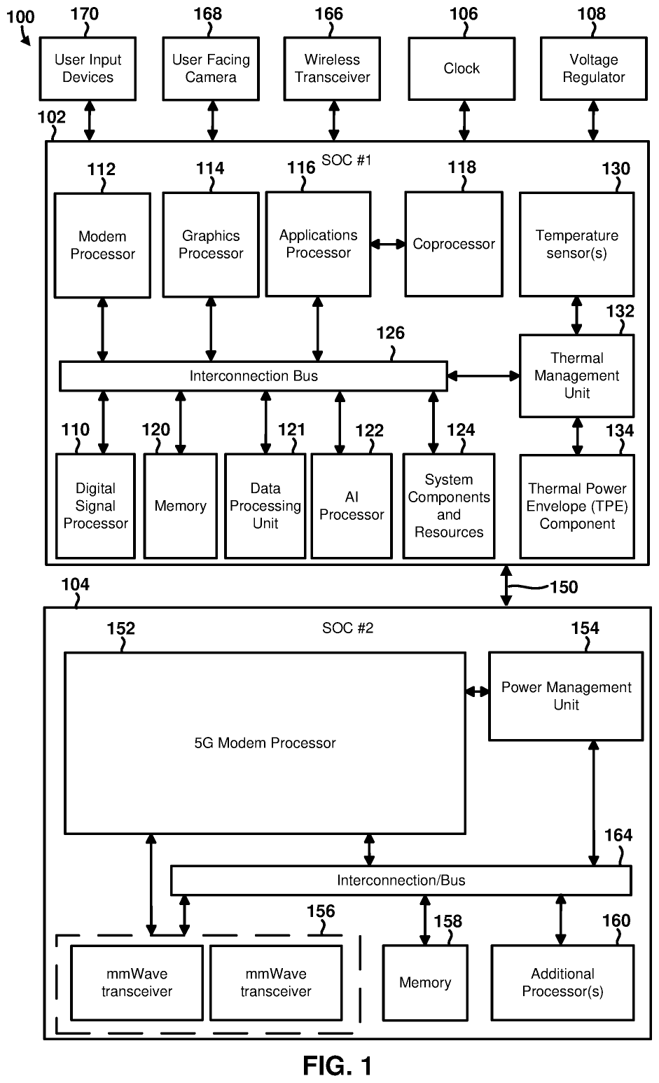

Various embodiments may be implemented on a number of single-processor and multiprocessor computer systems, including a system-on-chip (SOC) or system in a package (SIP). FIG. 1 illustrates an example computing system or SIP 100 architecture that may be used in mobile computing devices implementing a continuous speech-monitoring artificial intelligence (AI) system in accordance with various embodiments.

With reference to FIG. 1, the illustrated example SIP 100 includes two SOCs 102, 104, a clock 106, a voltage regulator 108, a wireless transceiver 166, a user facing camera 168 and user input devices 170 (e.g., a touch-sensitive display, a touch pad, a mouse, etc.). The first and second SOC 102, 104 may communicate via interconnection bus 150. Various processors 110, 112, 114, 116, 118, 121, 122, may be interconnected to each other and to one or more memory elements 120, system components and resources 124, and a thermal management unit 132 via an interconnection bus 126, which may include advanced interconnects such as high-performance networks-on-chip (NOCs). Similarly, the processor 152 may be interconnected to the power management unit 154, the mmWave transceivers 156, memory 158, and various additional processors 160 via the interconnection bus 164. These interconnection buses 126, 150, 164 may include an array of reconfigurable logic gates and/or implement a bus architecture (e.g., CoreConnect, AMBA, etc.). Communications may be provided by advanced interconnects, such as NOCs.

In various embodiments, any, or all of the processors 110, 112, 114, 116, 121, 122, in the system may operate as the SoC's main processor, central processing unit (CPU), microprocessor unit (MPU), arithmetic logic unit (ALU), etc. One or more of the coprocessors 118 may operate as the CPU.

In some embodiments, the first SOC 102 may operate as the central processing unit (CPU) of the mobile computing device that carries out the instructions of software application programs by performing the arithmetic, logical, control and input/output (I/O) operations specified by the instructions. In some embodiments, the second SOC 104 may operate as a specialized processing unit. For example, the second SOC 104 may operate as a specialized 5G processing unit responsible for managing high volume, high speed (e.g., 5 Gbps, etc.), and/or very high-frequency short wavelength (e.g., 28 GHz mmWave spectrum, etc.) communications.

The first SOC 102 may include a digital signal processor (DSP) 110, a modem processor 112, a graphics processor 114, an application processor 116, one or more coprocessors 118 (e.g., vector co-processor, CPUCP, etc.) connected to one or more of the processors, memory 120, data processing unit (DPU) 121, artificial intelligence processor 122, system components and resources 124, an interconnection bus 126, one or more temperature sensors 130, a thermal management unit 132, and a thermal power envelope (TPE) component 134. The second SOC 104 may include a 5G modem processor 152, a power management unit 154, an interconnection bus 164, a plurality of mmWave transceivers 156, memory 158, and various additional processors 160, such as an applications processor, packet processor, etc.

Each processor 110, 112, 114, 116, 118, 121, 122, 121, 122, 152, 160 may include one or more cores, and each processor/core may perform operations independent of the other processors/cores. For example, the first SOC 102 may include a processor that executes a first type of operating system (e.g., FreeBSD, LINUX, OS X, etc.) and a processor that executes a second type of operating system (e.g., MICROSOFT WINDOWS 11). In addition, any, or all of the processors 110, 112, 114, 116, 118, 121, 122, 121, 122, 152, 160 may be included as part of a processor cluster architecture (e.g., a synchronous processor cluster architecture, an asynchronous or heterogeneous processor cluster architecture, etc.).

Any or all of the processors 110, 112, 114, 116, 118, 121, 122, 121, 122, 152, 160 may operate as the CPU of the mobile computing device. In addition, any, or all of the processors 110, 112, 114, 116, 118, 121, 122, 121, 122, 152, 160 may be included as one or more nodes in one or more CPU clusters. A CPU cluster may be a group of interconnected nodes (e.g., processing cores, processors, SOCs, SIPs, computing devices, etc.) configured to work in a coordinated manner to perform a computing task. Each node may run its own operating system and contain its own CPU, memory, and storage. A task that is assigned to the CPU cluster may be divided into smaller tasks that are distributed across the individual nodes for processing. The nodes may work together to complete the task, with each node handling a portion of the computation. The results of each node's computation may be combined to produce a final result. CPU clusters are especially useful for tasks that can be parallelized and executed simultaneously. This allows CPU clusters to complete tasks much faster than a single, high-performance computer. Additionally, because CPU clusters are made up of multiple nodes, they are often more reliable and less prone to failure than a single high-performance component.

The first and second SOC 102, 104 may include various system components, resources, and custom circuitry for managing sensor data, analog-to-digital conversions, wireless data transmissions, and for performing other specialized operations, such as decoding data packets and processing encoded audio and video signals for rendering in a web browser. For example, the system components and resources 124 of the first SOC 102 may include power amplifiers, voltage regulators, oscillators, phase-locked loops, peripheral bridges, data controllers, memory controllers, system controllers, Access ports, timers, and other similar components used to support the processors and software clients running on a computing device. The system components and resources 124 may also include circuitry to interface with peripheral devices, such as cameras, electronic displays, wireless communication devices, external memory chips, etc.

The first and/or second SOCs 102, 104 may further include an input/output module (not illustrated) for communicating with resources external to the SOC, such as the clock 106, the voltage regulator 108, the wireless transceiver 166 (e.g., cellular wireless transceiver, Bluetooth transceiver, etc.), the user facing camera 168 and user input devices 170 (e.g., a touch-sensitive display, a touch pad, a mouse, etc.). Resources external to the SOC (e.g., clock 106, voltage regulator 108, wireless transceiver 166) may be shared by two or more of the internal SOC processors/cores. Further, the first and/or second SOCs 102, 104 be configured with modules for processing data received from the user facing camera 168 and user input devices 170 to track a user's attention as described herein.

In addition to the example SIP 100 discussed above, various embodiments may be implemented in various computing systems, including a single processor, multiple processors, multicore processors, or any combination thereof.

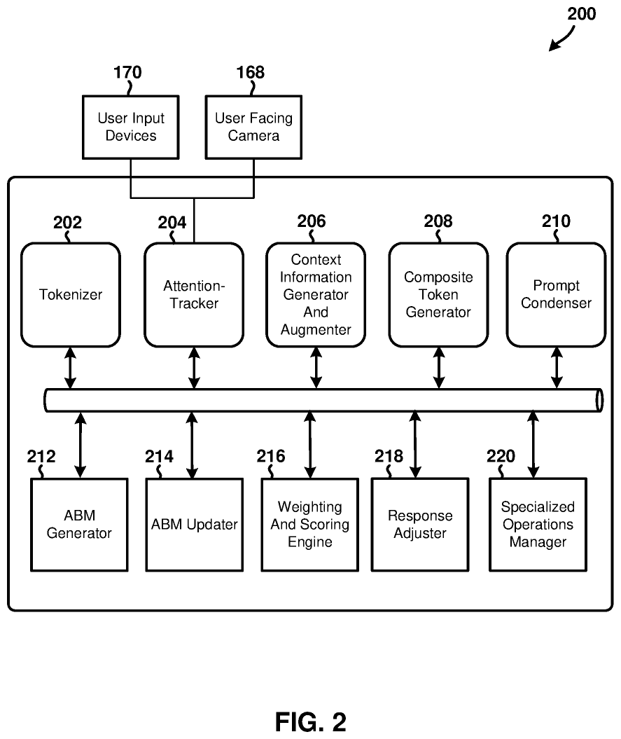

FIG. 2 illustrates example components that could be included in a system configured to implement the various embodiments. With reference to FIGS. 1 and 2, a system 200 (e.g., SIP 100, SOCs 102, 104, etc.) may include one or more of a tokenizer 202 component, attention-tracker 204 component, context information generator and augmenter 206 component, composite token generator 208 component, prompt condenser 210 component, ABM generator 212 component, ABM updater 214 component, weighting and scoring engine 216 component, response adjuster 218 component, and specialized operations manager 220 component.

The tokenizer 202 component may be configured to tokenize user prompts and contextual information. For example, the tokenizer 202 component may sequentially examine each character in an original user prompt or contextual information, mark special characters that serve as separators like spaces or commas, and use identified delimiters to further divide the original text string into smaller segments or tokens, identify and discard extraneous characters or words, convert the text into a format that is more amenable for neural network processing, and/or perform other similar operations.

The attention-tracker 204 component may be configured to receive data from sensors and/or sources of user attention information. In some aspects, the attention-tracker 204 may be configured to receive data from a user-facing camera 168 and/or user input devices 170 (e.g., touch-sensitive display, mouse, trackball, etc.) and process such data to track the user's current focus or attention metrics (e.g., gaze, mouse clicks, scrolling actions, etc.).

The attention-tracker 204 may monitor and record various metrics (e.g., ABMs, etc.) suitable for determining dimensions of user interaction and focus, such as user attention, user engagement, user focal point, and/or user area of interest within a digital environment. The attention-tracking operations may include (but is not limited to) using an eye-tracking sensor to follow the movement of the user's eyes, capturing metrics such as gaze duration, saccades, and fixations, and categorizing a webpage section as being of interest (or potentially confusing, etc.) in response to determining that the user's gaze lingered longer on that specific section.

The context information generator and augmenter 206 component may be configured to use ABMs to derive contextual information relevant to the user prompt and relevant to the user's current attention, dynamically adjust the contextual information, and/or augment the contextual information with data received from external data sources.

The composite token generator 208 component may be configured to construct composite tokens based on the user prompt and contextual information, such as by merging, augmenting, or amalgamating the original prompt tokens with the weighted contextual tokens. In some embodiments, the composite token generator 208 component may be configured to use the composite token (e.g., original prompt token+weighted contextual tokens) to generate an enhanced prompt, which may integrate the original user prompt and the content displayed on the device to which the user directed attention. The enhanced prompt may include, for example, details related to the content displayed on the device that had caught the user's attention (at the time or prior to the prompt), a textual summary of the subject matter displayed on the device that had caught the user's attention, etc.

The prompt condenser 210 component may be configured to shorten the length of enhanced prompts by retaining only those elements that are most aligned with the user's focus and interests. In some embodiments, the prompt condenser 210 component may be configured to reduce or eliminate tokens and non-adaptive textual prompts that are not consistent with the ABMs (e.g., prompts that do not align with the user's current behavior or interests, etc.). In some embodiments, the prompt condenser 210 component may be configured to generate a summary prompt that includes terms that are given greater weight based on the user's attention metrics. In some embodiments, the prompt condenser 210 component may be configured to scan the composite set of tokens, evaluate their respective weights, dynamically determine a weight threshold (e.g., 0.5), remove, deprecate, or depreciate tokens that fall below the weight threshold, compile the remaining high-weight tokens into a condensed prompt for further processing, and validate the condensed prompt to ensure it still represents the user's current state of attention as indicated by ABMs.

The ABM generator 212 component may be configured to generate ABM data units or information structures that quantify, measure, or otherwise characterize various facets of user attention, user engagement, user focal point, user area of interest. In some embodiments, the ABM generator 212 component may generate ABMs based on data and information collected by the attention-tracker 204 component. In some embodiments, the ABM generator 212 component may perform feature extraction operations that identify and label metrics (e.g., gaze duration, cursor speed, etc.) as data features of interest, feed the identified data features into a machine learning model for training or identifying patterns, and perform other similar operations. The ABM updater 214 component may be configured to dynamically update the ABMs to maintain their relevance based on the user's current behavior, such as by performing any or all of the operations of the ABM generator 212 component discussed above.

The weighting and scoring engine 216 component may be configured to assign or allocate numerical importance to tokens originating from the user prompt and to the contextual tokens. The weighting and scoring engine 216 component may determine the weight assignments based on factors such as their relevance and their potential to improve the quality of LXM-generated content. These weight assignments may be subjected to dynamic adjustments influenced by shifts in user focus or interest. In addition, the weighting and scoring engine 216 component may variably score and weight these tokens in accordance with the most recent ABMs and detected levels of user engagement.

In some embodiments, the weighting and scoring engine 216 may be configured to apply adaptive weighting techniques to certain segments of the original user prompt. These techniques may be influenced by levels of user focus. For example, the weighting and scoring engine 216 may introduce an attentional bias to specific terms within the original prompt, contingent upon the duration and intensity of user engagement with those terms as they appear in displayed content.

In some embodiments, the weighting and scoring engine 216 may implement or include tailored scoring algorithms for each individual token or word in the text, informed by the ABMs. For example, the weighting and scoring engine 216 may increase weight scores associated with tokens that correspond to terms in the content in which the user focuses attention. The weighting and scoring engine 216 may assign a diminished initial weight and a quicker rate of weight decay to commonly occurring words with lesser informational content.

In some embodiments, the weighting and scoring engine 216 may be configured to increment scores, or alternatively, apply bonus scores to certain tokens in response to determining that they align with the user's original prompt or query. In some embodiments, the weighting and scoring engine 216 may reduce or moderate the rate of decay for these particular tokens, making them more likely to be factored into subsequent activities like content summarization or contextual embedding.

In some embodiments, the weighting and scoring engine 216 may be configured to implement and use exponential decay functions as a part of its scoring algorithms, providing a model for the change in attention each token receives over time. This functionality may allow for nuanced adjustments in alignment with the temporal ebb and flow of user focus.

In some embodiments, the weighting and scoring engine 216 may be configured to use word-level attention scores to improve the performance and functioning of LXMs. In some embodiments, the weighting and scoring engine 216 may be configured to deeply integrate individual token or word scores into the attention mechanisms of the LXMs, thereby elevating the quality of content representation and generated output.

In some embodiments, the weighting and scoring engine 216 may be configured to convert multimodal context into attention scores. The weighting and scoring engine 216 may use features of the local computing device (e.g., mobile device, etc.) to gather user attention data and translate the gathered data into attention scores that serve to enhance the LXM's understanding of user focus and contextual relevance.

In some embodiments, the weighting and scoring engine 216 may be configured to implement an adaptive control mechanism that dynamically adjusts word-level attention scores based on various factors, including user behavior and existing LXM scores. These word-level attention scores may either depreciate over time or escalate, depending on user focus, thereby offering a nuanced control over the model's attentional focus. Tokens or words deemed noteworthy might experience a slower rate of score decay. This decelerated decay rate may make these tokens more likely to impact future operations and improve the output's relevance.

In some embodiments, the weighting and scoring engine 216 may be configured to adjust word-level scores based on their relevance to the original user prompt or query. Such adjustments may influence the LXM's attention and prediction accuracy.

In some embodiments, the weighting and scoring engine 216 may be configured to use word-level attention scores for context compression. The weighting and scoring engine 216 may generate a compact yet informative representation of context information that allows for more efficient processing and output generation.

In some embodiments, the weighting and scoring engine 216 may be configured to detect variations in contextualized output given identical queries but divergent temporal contexts. The weighting and scoring engine 216 may fine tune the levels of contextual information so that the generated output remains in alignment with the temporal dynamics of the original user prompt.

The response adjuster 218 component may be configured to receive and adjust the LXM output so that it is more aligned with the user's current focus, interests, or behaviors. For example, the response adjuster 218 component may retrieve and review the latest ABM data to determine the user's current attention or the degree of user engagement (or user's current attention span, interests, behavior, etc.), adjust the style, length, or complexity of the response based on the latest ABM data and the user's current attention or the degree of user engagement, determine and select an appropriate medium (e.g., text, images, video, etc.) based on the user's recent interactions, generate a tailored response for the selected medium that includes the adjustments, and present the tailored response through a user interface

The specialized operations manager 220 component may be configured to perform and manage various specialized tasks such as time-sensitive summarization, visual interpretation, and enhanced speech recognition. operations.

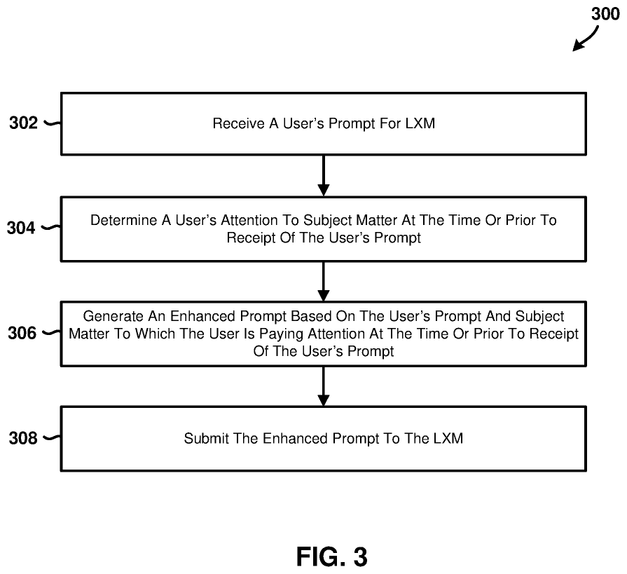

FIG. 3 is a process flow diagram illustrating a method 300 of generating a prompt for a large generative AI model (LXM) in accordance with some embodiments. With reference to FIGS. 1-3, the method 300 may be performed in a computing device by at least one processor or a processing system encompassing one or more processors (e.g., 110, 112, 114, 116, 118, 121, 122, 121, 122, 152, 160, etc.), components or subsystems discussed in this application. Means for performing the functions of the operations in the method 300 may include at least one processor including one or more of processors 110, 112, 114, 116, 118, 121, 122, 121, 122, 152, 160, and other components described herein. Further, one or more processors of at least one processor may be configured with software or firmware to perform some or all of the operations of the method 300. In order to encompass the alternative configurations enabled in various embodiments, the hardware implementing any or all of the method 300 is referred to herein as “at least one processor.”

In various embodiments, the operations of method 300 may be performed by or may make use of any of the tokenizer 202 component, attention-tracker 204 component, context information generator and augmenter 206 component, composite token generator 208 component, prompt condenser 210 component, ABM generator 212 component, ABM updater 214 component, weighting and scoring engine 216 component, response adjuster 218 component, and/or specialized operations manager 220 component illustrated and described with reference to FIG. 2.

In block 302, the at least one processor may receive a user's prompt for a large generative AI model (LXM). For example, the user may enter a string of characters (e.g., “Hello, AI!”) into a text box on an application interface, and the at least one processor (or a corresponding application) may capture and store the string of characters in memory as an original prompt. In some embodiments, the user prompt received in block 302 may be for an LLM.

In block 304, the at least one processor may determine a user's attention to subject matter at the time or prior to receipt of the user's prompt. The subject matter may be associated with the computing device (e.g., displayed on the computing device, etc.) and/or one or more other nearby devices (e.g., watching TV while using the computing device, music playing from smart speaker, etc.) at the time or prior to receipt of the user's prompt. In some embodiments, the at least one processor may determine the user's attention by tracking the user's eye gaze on subject matter displayed on the computing device (or another nearby device, etc.), tracking a mouse cursor location on subject matter displayed on the computing device (or another nearby device, etc.), and/or tracking the user's touch locations on subject matter displayed on the computing device (or another nearby device, etc.).

In block 306, the at least one processor may generate an enhanced prompt based on the user's prompt and the determined user's attention to subject matter at the time or prior to receipt of the user's prompt. In some embodiments, generating the enhanced prompt may include generating a summary prompt that includes words assigned a greater weight based on the user's attention to the subject matter at the time or prior to receipt of the user's prompt.

In some embodiments, the at least one processor may apply adaptive important weighting to portions of the user's prompt based on the user's attention to the subject matter at the time or prior to receipt of the user's prompt. For example, the at least one processor may add an attention bias weight to words in the user's prompt based on observations of the user's attention paid to words or phrases in the displayed subject matter prior to the entry of the user's prompt. In some embodiments, the at least one processor may increase the attention bias weight responsive to the duration the user focuses on particular words and decrease the attention bias weight with time after the user focus shifts away from the particular words. In some embodiments, the amount by which the attention bias weight is increased responsive to the duration the user focuses on the particular words and decreases with time after the user focus shifts away from the particular words may depend on the type of word, the relevance of the words to the user's prompt, and/or the uniqueness of the words.

In some embodiments, the at least one processor may generate the enhanced prompt to include information regarding the subject matter (e.g., associated with the computing device, associated with a nearby device, etc.) to which the user paid attention to at the time or prior to receipt of the user's prompt. For example, the at least one processor may generate text summarizing the subject matter to which the user paid attention to at the time or prior to receipt of the user's prompt and include at least a portion of the generated text in the enhanced prompt.

In block 308, the at least one processor may submit the enhanced prompt to the LXM. In some embodiments, the LXM may be included in the computing device from which the user's prompt was received. In some embodiments, the LXM may be on a different computing device (e.g., remote server, nearby device, etc.) than the one in which the user's prompt was received. For example, in some embodiments, the at least one processor may convert the enhanced prompt into a serialized format that is compatible with the LXM, issue an application programming interface (API) call to submit the serialized prompt to the LXM, establish a secure connection to the LXM system, transmit the serialized prompt to LXM system, and receive a generative response from the LXM, which the at least one processor may present to the user, such as in a display or by synthesized voice. In some embodiments, the at least one processor may submit the enhanced prompt to an LLM.

In some embodiments, the at least one processor may render the enhanced prompt on a display and allow the user to edit the enhanced prompt before submission to the LXM. In some embodiments, the at least one processor may send the user an updated enhanced prompt and/or update the enhanced prompt based on the user edits prior to submission to the LXM. In some embodiments, the at least one processor may submit the enhanced prompt without the user seeing or knowing the contents of the enhanced prompt.

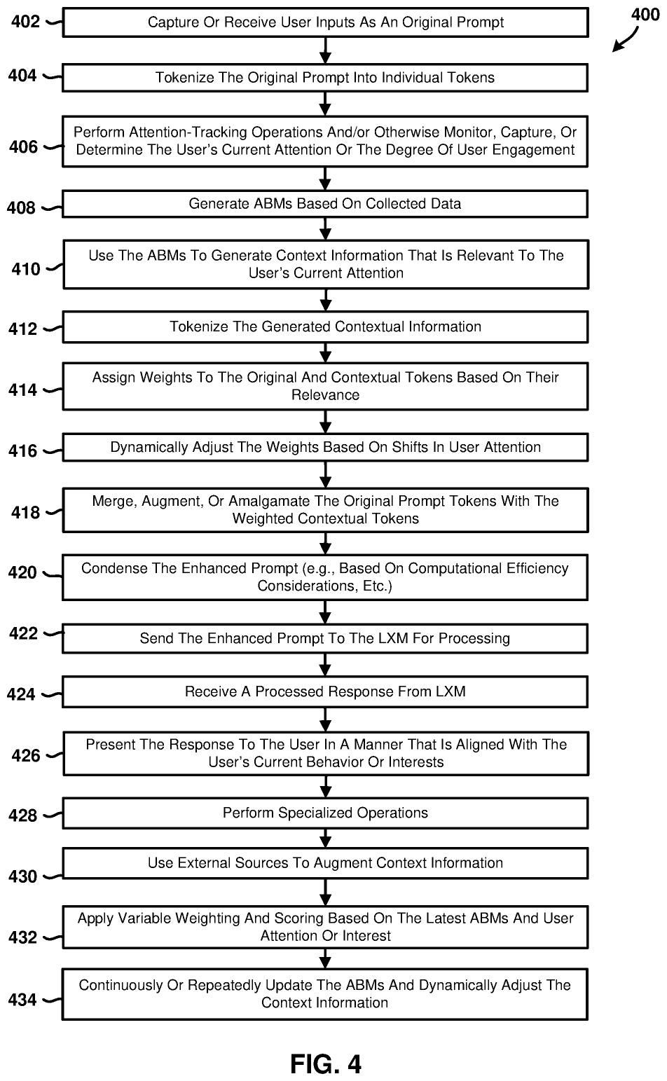

FIG. 4 is a process flow diagram illustrating a more detailed method 400 of generating a prompt for a large generative AI model (LXM) in accordance with some embodiments. FIG. 4 extends and complements the methods, components, and information structures illustrated and described with reference to FIGS. 2 and 3. With reference to FIGS. 1-4, the method 400 may be performed in a computing device by at least one processor encompassing one or more processors (e.g., 110, 112, 114, 116, 118, 121, 122, 121, 122, 152, 160, etc.), components or subsystems discussed in this application. Means for performing the functions of the operations in the method 400 may include at least one processor including one or more of processors 110, 112, 114, 116, 118, 121, 122, 121, 122, 152, 160, and other components described herein. Further, one or more processors of at least one processor may be configured with software or firmware to perform some or all of the operations of the method 400. In order to encompass the alternative configurations enabled in various embodiments, the hardware implementing any or all of the method 400 is referred to herein as a “at least one processor.”

For the sake of clarity and ease of presentation, methods 300 and 400 are presented as separate embodiments. While each method is delineated for illustrative purposes, it should be clear to those skilled in the art that various combinations or omissions of these methods, blocks, operations, etc. could be used to achieve a desired result or a specific outcome. It should also be understood that the descriptions herein do not preclude the integration or adaptation of different embodiments of the methods, blocks, operations, etc. to produce a modified or alternative result or solution. The presentation of individual methods, blocks, operations, etc. should not be interpreted as mutually exclusive, limiting, or as being required unless expressly recited as such in the claims.

In block 402, the at least one processor may capture or receive user inputs as an original prompt. For example, the user may enter a string of characters (e.g., “Hello, AI!”) into a text box on an application interface, and the at least one processor (or a corresponding application) may capture and store the string of characters in memory as an original prompt.

In block 404, the at least one processor may tokenize the original prompt into individual tokens. Tokenization, or the process of breaking down text into discrete elements, may include tasks such as recognizing individual characters, distinguishing delimiters, and creating tokens. For example, in block 404 the at least one processor may sequentially examine each character the text string stored in memory as the original input, mark special characters that serve as separators like spaces or commas, and use identified delimiters to further divide the original text string into smaller segments or tokens. To provide a more concrete example, if the original input is “Hello, AI!”, the resulting tokens may be “Hello”, “,”, “AI”, and “!”. Such tokenization may help the at least one processor identify and discard extraneous characters or words, convert the text into a format that is more amenable for neural network processing, and/or facilitate a deeper understanding of the text's underlying context.

In block 406, the at least one processor may perform attention-tracking operations and/or otherwise monitor, capture, or determine the user's current attention or the degree of user engagement. The attention-tracking operations may be multifaceted and employ sub methods to determine the degree of user engagement. For example, attention-tracking operations may include using eye-tracking devices or sensors to follow the movement of the user's eyes. These devices/sensors may capture metrics such as gaze duration, saccades, and fixations. For example, the at least one processor may label a webpage section as being of interest or potentially confusing in response to determining that the user's gaze lingered longer on that specific section. As another example, the attention-tracking operations may include performing cursor behavior analysis operations based on cursor movements, which may indicate user attention or engagement. Rapid movement, hovering over specific areas, or frequent clicks could offer clues about the sections of the webpage or electronic display that garner attention and/or may require further investigation.

In block 408, the at least one processor may generate ABMs based on collected data. For example, the at least one processor may filter the raw data to remove outliers or anomalies, perform feature extraction operations that identify and label metrics (e.g., gaze duration, cursor speed, etc.) as data features of interest, feed the identified data features into a machine learning model for training or identifying patterns, and/or assign scores to different areas, elements, tokens, etc. based on the degree of attention they receive. As a further example, the at least one processor may assign a high attention score to a section that includes a call-to-action button in response to determining based on eye-tracking data that 80% of users fixate on a call-to-action button for at least 5 seconds.

In block 410, the at least one processor may use the ABMs to generate context information that is relevant to the user's current attention. For example, the at least one processor may analyze the ABMs to derive insights into where the user's attention is primarily focused and use the attention data to generate contextually relevant information or actions. For example, dwell time on certain areas of an interface may indicate heightened interest or potential confusion. As a further example, eye-tracking data and cursor movement data collected from a user reading an online article about renewable energy may indicate sustained attention to sections discussing solar panels, and the corresponding ABMs may indicate a 7-second gaze duration on the “solar panel efficiency” section and multiple hovers over related hyperlinks. The at least one processor may use this information to determine that user behavior indicates a heightened interest in solar panel technology and generate the contextual information to include data relevant to solar panel efficiency or related technologies.

In block 412, the at least one processor may tokenize the generated contextual information. For example, the at least one processor may generate contextual information based on the ABM, remove redundant or spurious elements, format the generated contextual information, segment the contextual information into textual elements (e.g., a paragraph, sentence, clause, word, sub-word, character, etc.), and convert each segmented textual element into a token that is more easily processed or analyzed by the system.

For example, if the generated contextual information includes the string: “Renewable energy is advantageous. Solar panels are efficient.”, the at least one processor may remove the special charters and identify and separate the sentences to generate [“renewable energy is advantageous”, “solar panels are efficient”], further decompose each sentence into individual words (or subwords or character(s)) to generate tokens such as [“renewable”, “energy”, “is”, “advantageous”] for the first sentence and [“solar”, “panels”, “are”, “efficient”] for the second sentence.

In block 414, the at least one processor may assign weights to the original and contextual tokens based on their relevance, which in some embodiments may be determined based on the ABMs. For example, the at least one processor may generate ABMs that include real-time metrics such as cursor movements, dwell time, or eye-tracking data, analyze the metrics to determine areas of interest or focus for the user, use the results of the analysis to evaluate each token from the original and contextual information, and assign relevance scores or numerical values to each token.

For example, if the original prompt includes the string “Tell me about renewable energy.”, the contextual information includes “solar power,” “wind turbines,” and “hydroelectricity,” and the ABMs indicate that the cursor hovered over “solar power” for an extended period and eye-tracking data indicated a strong focus on “wind turbines,” the at least one processor may determine that “solar power,” and “wind turbines,” are of greater importance to the user than “hydroelectricity.” The at least one processor may evaluate tokens such as “renewable”, “energy”, “solar”, “power”, “wind”, “turbines,” etc., and assign higher weights to the tokens related to “solar power” and “wind turbines.” For example, the at least one processor may assign weights to the tokens as follows [renewable: 0.2; energy: 0.2; solar: 0.8; power: 0.7; wind: 0.9; turbines: 0.9; hydroelectricity: 0.4].

In block 416, the at least one processor may dynamically adjust the weights based on shifts in user attention. For example, the at least one processor may monitor the real-time ABM data such as (but not limited to) cursor movements, click-through rates, and eye-tracking metrics, analyze the monitored data to identify changes in the user's focus or areas of interest, use the updated metrics to reevaluate the weights assigned to the original and contextual tokens, and update the token weights based on the newly identified shifts in user attention. Continuing the above example, the at least one processor may detect a shift in the user's eye movements toward the term “hydroelectricity,” hydroelectricity has grown in importance to the user (or that the user's current attention or the degree of user engagement has increased with respect to this token), and reevaluate and update the weights associated with the tokens. For example, the at least one processor may update the weights assigned to the tokens as follows [renewable: 0.2; energy: 0.2; solar: 0.5; power: 0.4; wind: 0.6; turbines: 0.6; hydroelectricity: 0.8].

In block 418, the at least one processor may merge, augment, or amalgamate the original prompt tokens with the weighted contextual tokens to generate composite tokens and/or an enhanced prompt. For example, the at least one processor may identify the original prompt tokens and the weighted contextual tokens, evaluate the weights associated with each token, generate a composite set of tokens, prioritize tokens with higher weights in the composite set, add to the composite set any new tokens that gained importance (e.g., determined based on the real-time monitoring of ABM data, etc.), and use the composite set of tokens to generate a user-relevant response or action. Continuing the above example in which the original prompt includes the string “tell me about renewable energy,” original tokens [tell: 0.1; me: 0.1; about: 0.1; renewable: 0.7; energy: 0.9], and contextual tokens [solar: 0.5; power: 0.4; wind: 0.6; turbines: 0.6; hydroelectricity: 0.8], the at least one processor may generate the composite set of tokens [tell: 0.1; me: 0.1; about: 0.1; renewable: 0.7; energy: 0.9; solar: 0.5; power: 0.4; wind: 0.6; turbines: 0.6; hydroelectricity: 0.8].

In block 420, the at least one processor may condense the enhanced prompt, such as based on computational efficiency and other considerations. For example, the at least one processor may scan the composite set of tokens, evaluate their respective weights, dynamically determine a weight threshold (e.g., 0.5), remove, deprecate, or depreciate tokens that fall below the weight threshold, compile the remaining high-weight tokens into a condensed prompt for further processing, and validate the condensed prompt to ensure it still represents the user's current state of attention as indicated by ABMs. Continuing the above example in which the original prompt includes the string “Tell me about renewable energy.”, original tokens [tell: 0.1; me: 0.1; about: 0.1; renewable: 0.7; energy: 0.9], contextual tokens [solar: 0.5; power: 0.4; wind: 0.6; turbines: 0.6; hydroelectricity: 0.8], and composite tokens [tell: 0.1; me: 0.1; about: 0.1; renewable: 0.7; energy: 0.9; solar: 0.5; power: 0.4; wind: 0.6; turbines: 0.6; hydroelectricity: 0.8], the at least one processor may generate the condensed composite token set [renewable: 0.7; energy: 0.9; solar: 0.5; wind: 0.6; turbines: 0.6; hydroelectricity: 0.8].

In block 422, the at least one processor may send the enhanced (and possibly condensed) prompt to the LXM for processing. In some embodiments, the LXM may be included in the computing device from which the user's prompt was received. In some embodiments, the LXM may be on a different computing device (e.g., remote server, nearby device, etc.) than the one in which the user's prompt was received. For example, in some embodiments, the at least one processor may convert the enhanced prompt into a serialized format that is compatible with the LXM, issue an API call to submit the serialized prompt to the LXM, establish a secure connection to the LXM system, transmit the serialized prompt to LXM system, and receive an acknowledgment signal confirming the receipt of the prompt from the LXM.

In block 424, the at least one processor may receive a generated response from LXM. In some embodiments, the response may be generated in the computing device from which the user's prompt was received. In some embodiments, the response may be generated on a different computing device (e.g., remote server, nearby device, etc.) than the one in which the user's prompt was received. For example, in some embodiments, the at least one processor may monitor an active API listener that is prepared to receive the output from the LXM, receive an encrypted communication, decrypt the incoming data and verify its integrity, convert the serialized data back into a usable format, evaluate a status code included in the received response to determine the success or failure of the LXM's processing tasks, and/or perform other similar operations.

The at least one processor may present the LXM response. In some embodiments, in block 426, the at least one processor may present the LXM response to the user in a manner that is aligned with the user's current behavior or interests. For example, the at least one processor may retrieve and review the latest ABM data to determine the user's current attention or the degree of user engagement (or user's current attention span, interests, behavior, etc.), adjust the style, length, or complexity of the response based on the latest ABM data and the user's current attention or the degree of user engagement, determine and select an appropriate medium (e.g., text, images, video, etc.) based on the user's recent interactions, generate a tailored response for the selected medium that includes the adjustments, and present the tailored response through a user interface.

In some embodiments, in block 428, the at least one processor may perform specialized operations, such as (but not limited to) time-sensitive summarization operations, visual interpretation operations, enhanced speech recognition operations, and/or other specialized operations. For example, in response to user commands such as “summarize this paragraph” or “summarize the previous story,” the at least one processor may perform time-sensitive summarization operations that use ABMs to decide the portions of the text that should be prioritized in the summarization. Using the ABMs may include using attention metrics (e.g., time spent on each paragraph, eye movements, etc.) to generate a summary that not only condenses the information but also prioritizes concepts or terms that had previous captured the user's attention (or prioritizes concepts or terms that had not captured the user's attention, etc.).

In some embodiments, the at least one processor may perform visual interpretation operations, such as converting text to images in response to a user command to “illustrate the current paragraph for my child.” In doing so, the at least one processor could consider various factors such as the subject matter of the current paragraph that is the focus of the user's attention, recent areas of focus, the child's age, etc. to generate a relevant and engaging illustration.

In some embodiments, in block 430, the at least one processor may use external sources to augment context information. For example, for a user prompt asking questions related to current events, the at least one processor may retrieve and use data from an external news feed to ensure the contextual information is relevant and up to date. As another example, for a user prompt asking about popular opinions on a subject matter, the at least one processor may access social media APIs to collect trending hashtags or phrases related to the topic or subject matter and use these data points to construct more robust and socially relevant contextual information. In some embodiments, the at least one processor may cross-reference a user's online activity or data stored in other applications (e.g., calendars, to-do lists, browser history, etc.) to better understand the user and generate more relevant contextual information. In some embodiments, the at least one processor may be configured to augment the contextual information based on real-time data collected from biometric sensors or environmental sensors. For example, the at least one processor may check to determine whether a room temperature sensor indicates a hot environment in response to receiving a user prompt query about “comfortable living,” and augment the context information to include information about the room or cooling down the user's environment. The at least one processor may also check academic journals or databases for scholarly or professional inquiries, access geolocation data in response to questions about “best restaurants,” etc.

In some embodiments, in block 432, the at least one processor may apply variable weighting and scoring based on the latest ABMs and user attention or interest. For example, in some embodiments, the at least one processor may assign weights to contextual tokens based on the probability or likelihood that the information may improve the LXM's output. These weighted tokens may be used to construct a more pertinent prompt, and as a result, generate responses that are better aligned with the user's current behavior or interests. In some embodiments, the at least one processor may assign attention bias weights to the tokens in the original user prompt and dynamically adjust the weights based on shifts in user focus.

In some embodiments, in block 434, the at least one processor may continuously or repeatedly update the ABMs and dynamically adjust the context information. The at least one processor may assign weights to tokens in the user's prompt based on real-time ABMs. For example, the tokens pertaining to climate change may be weighted higher in response to determining that the user's focus has been consistently on topics related to that subject. The at least one processor may also change the context information that is fed to the LXM based on the updated ABMs. For example, the at least one processor may adaptively update the context information in response to determining that the user was previously focused on economics but has now shifted attention to healthcare. The at least one processor may increase the scores and/or decrease the decay rates associated with tokens that the user engages with frequently so that those tokens remain relevant in contextual information for a longer period of time.

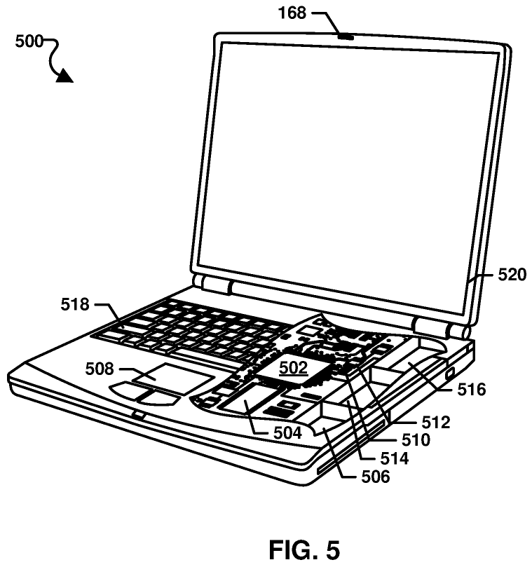

Various embodiments (including, but not limited to, embodiments described above with reference to FIGS. 1-4) may be implemented in a wide variety of wireless devices and computing systems including a laptop computer 500, an example of which is illustrated in FIG. 5. With reference to FIGS. 1-5, a laptop computer may include at least one processor 502 coupled to volatile memory 504 and a large capacity nonvolatile memory, such as a disk drive 506 or Flash memory. The laptop computer 500 may include a touchpad touch surface 508 that serves as the computer's pointing device. The touchpad touch surface 508 may be configured to provide data to the at least one processor 502 regarding drag, scroll, and flick gesture user inputs. The laptop computer 500 may also include a user-facing camera 168 coupled to the at least one processor 502. As described, in some embodiments the at least one processor 502 may include or be configured with an attention-tracker module (e.g., 204) that is configured to process data from the user-facing camera 168 and/or the touchpad touch surface 508 to track the user's attention to subject matter presented on the touch-sensitive display 612.

Additionally, the laptop computer 500 may have one or more antenna 510 for sending and receiving electromagnetic radiation that may be connected to a wireless data link and/or cellular telephone transceiver 512 coupled to the processor 502. The computer 500 may also include a BT transceiver 514, a compact disc (CD) drive 516, a keyboard 518, and a display 520 all coupled to the processor 502. Other configurations of the computing device may include a computer mouse or trackball coupled to the processor (e.g., via a universal serial bus (USB) input) as are well known, which may also be used in conjunction with various embodiments.

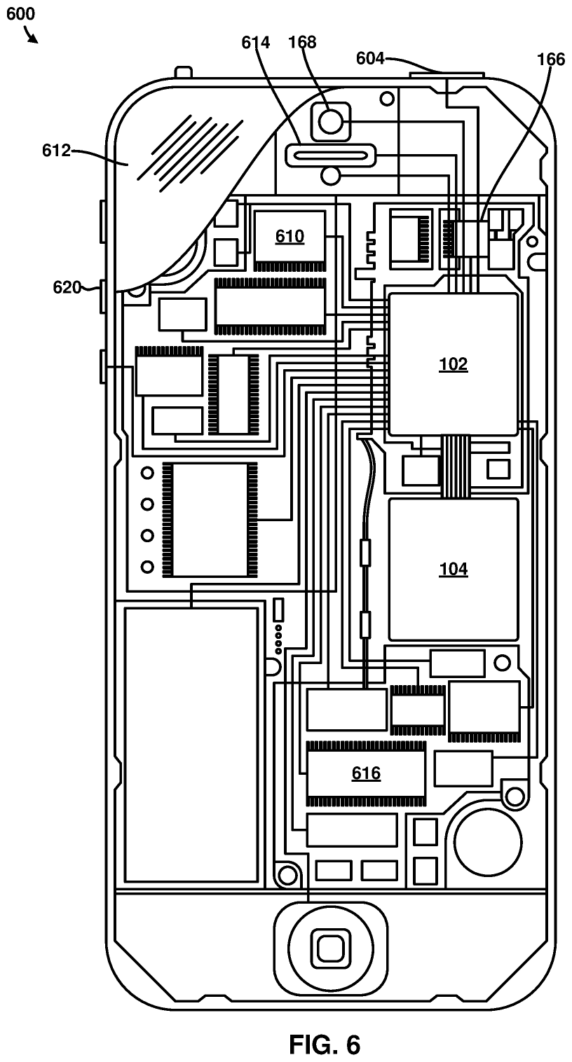

FIG. 6 is a component block diagram of a computing device 600 suitable for use with various embodiments. With reference to FIGS. 1-6, various embodiments may be implemented on a variety of computing devices 600, an example of which is illustrated in FIG. 6 in the form of a smartphone. The computing device 600 may include a first SOC 102 coupled to a second SOC 104. The first and second SoCs 102, 104 may be coupled to internal memory 616, a touch-sensitive display 612, a speaker 614, and a user-facing camera 168. As described, in some embodiments the first and second SoCs 102, 104 may include or be configured with an attention-tracker module (e.g., 204) that is configured to process data from the user-facing camera 168 and/or the touch-sensitive display 612 to track the user's attention to subject matter presented on the touch-sensitive display 612. The first and second SOCs 102, 104 may also be coupled to at least one subscriber identity module (SIM) 640 and/or a SIM interface that may store information supporting a first 5GNR subscription and a second 5GNR subscription, which support service on a 5G non-standalone (NSA) network.

The computing device 600 may include an antenna 604 for sending and receiving electromagnetic radiation that may be connected to a wireless transceiver 166 coupled to one or more processors in the first and/or second SOCs 102, 104. The computing device 600 may also include menu selection buttons or rocker switches 620 for receiving user inputs.

The computing device 600 also includes a sound encoding/decoding (CODEC) circuit 610, which digitizes sound received from a microphone into data packets suitable for wireless transmission and decodes received sound data packets to generate analog signals that are provided to the speaker to generate sound. Also, one or more of the processors in the first and second circuitries 102, 104, wireless transceiver 166 and CODEC 610 may include a digital signal processor (DSP) circuit (not shown separately).

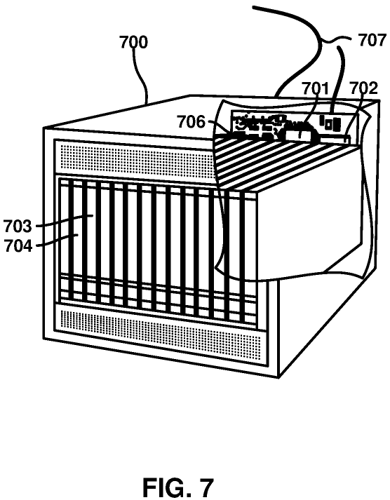

Some embodiments may be implemented on any of a variety of commercially available computing devices, such as the server computing device 700 illustrated in FIG. 7. Such a server device 700 may include a processor 701 coupled to volatile memory 702 and a large capacity nonvolatile memory, such as a disk drive 703. The server device 700 may also include a floppy disc drive, USB, etc. coupled to the processor 701. The server device 700 may also include network access ports 706 coupled to the processor 701 for establishing data connections with a network connection circuit 704 and a communication network 707 (e.g., an Internet protocol (IP) network) coupled to other communication system network elements.

The processors or processing units discussed in this application may be any programmable microprocessor, microcomputer, or multiple processor chip or chips that can be configured by software instructions (applications) to perform a variety of functions, including the functions of various embodiments described. In some computing devices, multiple processors may be provided, such as one processor within first circuitry dedicated to wireless communication functions and one processor within a second circuitry dedicated to running other applications. Software applications may be stored in the memory before they are accessed and loaded into the processor. The processors may include internal memory sufficient to store the application software instructions.

Implementation examples are described in the following paragraphs. While some of the following implementation examples are described in terms of example methods, further example implementations may include: the example methods discussed in the following paragraphs implemented by a computing device including a processor configured (e.g., with processor-executable instructions) to perform operations of the methods of the following implementation examples; the example methods discussed in the following paragraphs implemented by a computing device including means for performing functions of the methods of the following implementation examples; and the example methods discussed in the following paragraphs may be implemented as a non-transitory processor-readable storage medium having stored thereon processor-executable instructions configured to cause a processor of a computing device to perform the operations of the methods of the following implementation examples.

Example 1. A method performed by a computing device for generating a prompt for a generative artificial intelligence model (LXM), including: receiving a user's prompt for the LXM; determining a user's attention to the subject matter at the time or prior to receipt of the user's prompt; generating an enhanced prompt based on the user's prompt and subject matter displayed on the computing device to which the user is paying attention at the time or prior to receipt of the user's prompt; and submitting the enhanced prompt to the LXM.

Example 2. The method of example 1, in which generating the enhanced prompt based on the user's prompt and the subject matter to which the user is paying attention includes applying an adaptive important weighting to portions of the user's prompt based on the user's attention to the subject matter at the time or prior to receipt of the user's prompt.

Example 3. The method of either of examples 1 or 2, in which determining a user's attention to the subject matter includes one or more of tracking the user's eye gaze on the subject matter, tracking a mouse cursor location on the subject matter, or tracking the user's touch locations on the subject matter.

Example 4. The method of any of examples 1-3, in which generating the enhanced prompt includes generating a summary prompt that includes words assigned greater weight based on the user's attention to the subject matter at the time or prior to receipt of the user's prompt

Example 5. The method of any of examples 1-4, in which applying an adaptive important weighting to portions of the user's prompt based on the user's attention to the subject matter at the time or prior to receipt of the user's prompt includes adding an attention bias weight to words in the user's prompt based observations of the user's attention paid to words or phrases in the subject matter prior to entry of the user's prompt.

Example 6. The method of example 5, further including increasing the attention bias weight responsive to a duration the user focused on particular words and decreasing the attention bias weight with time after the user focus shifts away from the particular words.

Example 7. The method of example 6, in which an amount by which the attention bias weight is increased responsive to the duration the user focused on the particular words and decreases with time after the user focus shifts away from the particular words depends on one or more of a type of word, a relevance of the words to the user's prompt, or a uniqueness of the words.

Example 8. The method of any of examples 1-7, in which generating the enhanced prompt based on the user's prompt and the subject matter to which the user is paying attention includes including in the enhanced prompt information regarding the subject matter to which the user paid attention to at the time or prior to receipt of the user's prompt.

Example 9. The method of example 8, in which including in the enhanced prompt information regarding the subject matter to which the user paid attention to at the time or prior to receipt of the user's prompt includes: generating text describing a portion of the subject matter to which the user paid attention to at the time or prior to receipt of the user's prompt; and including at least a portion of the generated text in the enhanced prompt.

Example 10. The method of example 9, in which including in the enhanced prompt information regarding the subject matter to which the user paid attention to at the time or prior to receipt of the user's prompt includes: generating text summarizing the subject matter to which the user paid attention to at the time or prior to receipt of the user's prompt; and including at least a portion of the generated text in the enhanced prompt.

Example 11. The method of any of examples 1-10, in which determining the user's attention to the subject matter at the time or prior to receipt of the user's prompt includes determining the user's attention to subject matter associated with the computing device at the time or prior to receipt of the user's prompt.

Example 12. The method of any of examples 1-10, in which determining the user's attention to the subject matter at the time or prior to receipt of the user's prompt includes determining the user's attention to subject matter associated with another nearby device at the time or prior to receipt of the user's prompt.

Example 13. The method of any of examples 1-12, in which receiving the user's prompt for the LXM includes receiving the user's prompt for a large language model (LLM); and submitting the enhanced prompt to the LXM includes submitting the enhanced prompt to the LLM.

Example 14. The method of claim 16, in which: determining the user's attention to the subject matter at the time or prior to receipt of the user's prompt includes determining the user's attention to subject matter presented on a display of the computing device at the time or prior to receipt of the user's prompt; and generating the enhanced prompt based on the user's prompt and the subject matter to which the user is paying attention at the time or prior to receipt of the user's prompt includes generating the enhanced prompt based on the user's prompt and subject matter presented on the display to which the user is paying attention at the time or prior to receipt of the user's prompt.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

A number of different types of memories and memory technologies are available or contemplated in the future, any or all of which may be included and used in systems and computing devices that implement the various embodiments. Such memory technologies/types may include non-volatile random-access memories (NVRAM) such as Magnetoresistive RAM (M-RAM), resistive random access memory (ReRAM or RRAM), phase-change random-access memory (PC-RAM, PRAM or PCM), ferroelectric RAM (F-RAM), spin-transfer torque magnetoresistive random-access memory (STT-MRAM), and three-dimensional cross point (3D-XPOINT) memory. Such memory technologies/types may also include non-volatile or read-only memory (ROM) technologies, such as programmable read-only memory (PROM), field programmable read-only memory (FPROM), one-time programmable non-volatile memory (OTP NVM). Such memory technologies/types may further include volatile random-access memory (RAM) technologies, such as dynamic random-access memory (DRAM), double data rate (DDR) synchronous dynamic random-access memory (DDR SDRAM), static random-access memory (SRAM), and pseudostatic random-access memory (PSRAM). Systems and computing devices that implement the various embodiments may also include or use electronic (solid-state) non-volatile computer storage mediums, such as FLASH memory. Each of the above-mentioned memory technologies include, for example, elements suitable for storing instructions, programs, control signals, and/or data for use in a computing device, system on chip (SOC) or other electronic component. Any references to terminology and/or technical details related to an individual type of memory, interface, standard or memory technology are for illustrative purposes only, and not intended to limit the scope of the claims to a particular memory system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (TCUASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store target program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A computing device, comprising:
a memory; and
at least one processor coupled to the memory and configured to:
receive a user's prompt for a generative artificial intelligence model (LXM);
determine a user's attention to subject matter at the time or prior to receipt of the user's prompt;
generate an enhanced prompt based on the user's prompt and the subject matter to which the user is paying attention at the time or prior to receipt of the user's prompt; and
submit the enhanced prompt to the LXM.

2. The computing device of claim 1, wherein the at least one processor is further configured to generate the enhanced prompt based on the user's prompt and the subject matter to which the user is paying attention by applying an adaptive important weighting to portions of the user's prompt based on the user's attention to the subject matter at the time or prior to receipt of the user's prompt.

3. The computing device of claim 1, further comprising a user facing camera, wherein the at least one processor is further configured to determine the user's attention to the subject matter by tracking the user's eye gaze on the subject matter.

4. The computing device of claim 1, further comprising a touch sensitive display, wherein the at least one processor is further configured to determine the user's attention to the subject matter by tracking the user's touch locations on the touch sensitive display.

5. The computing device of claim 1, wherein the at least one processor is further configured to generate the enhanced prompt by generating a summary prompt that includes words assigned greater weight based on the user's attention to the subject matter at the time or prior to receipt of the user's prompt.

6. The computing device of claim 1, wherein the at least one processor is further configured to apply an adaptive important weighting to portions of the user's prompt based on the user's attention to the subject matter at the time or prior to receipt of the user's prompt by adding an attention bias weight to words in the user's prompt based observations of the user's attention paid to words or phrases in the subject matter prior to entry of the user's prompt.

7. The computing device of claim 6, wherein the at least one processor is further configured to increase the attention bias weight responsive to a duration the user focused on particular words and decreasing the attention bias weight with time after the user focus shifts away from the particular words.

8. The computing device of claim 7, wherein the at least one processor is further configured such that an amount by which the attention bias weight is increased responsive to the duration the user focused on the particular words and decreases with time after the user focus shifts away from the particular words depends on one or more of a type of word, a relevance of the words to the user's prompt, or a uniqueness of the words.

9. The computing device of claim 1, wherein the at least one processor is further configured to generate the enhanced prompt based on the user's prompt and the subject matter to which the user is paying attention by including in the enhanced prompt information regarding the subject matter to which the user paid attention to at the time or prior to receipt of the user's prompt.

10. The computing device of claim 9, wherein the at least one processor is further configured to include in the enhanced prompt information regarding the subject matter to which the user paid attention to at the time or prior to receipt of the user's prompt by:
generating text describing a portion of the subject matter to which the user paid attention to at the time or prior to receipt of the user's prompt; and
including at least a portion of the generated text in the enhanced prompt.

11. The computing device of claim 10, wherein the at least one processor is further configured to include in the enhanced prompt information regarding the subject matter to which the user paid attention to at the time or prior to receipt of the user's prompt by:
generating text summarizing the subject matter to which the user paid attention to at the time or prior to receipt of the user's prompt; and
including at least a portion of the generated text in the enhanced prompt.

12. The computing device of claim 1, wherein the at least one processor is further configured to determine the user's attention to subject matter at the time or prior to receipt of the user's prompt by determining the user's attention to subject matter associated with the computing device at the time or prior to receipt of the user's prompt.

13. The computing device of claim 1, wherein the at least one processor is further configured to determine the user's attention to subject matter at the time or prior to receipt of the user's prompt by determining the user's attention to subject matter associated with another nearby device at the time or prior to receipt of the user's prompt.

14. The computing device of claim 1, wherein the LXM is a large language model (LLM).

15. The computing device of claim 1, further comprising a display coupled to the at least one processor, wherein the at least one processor is configured to:
determine the user's attention to the subject matter at the time or prior to receipt of the user's prompt by determining the user's attention to subject matter presented on the display at the time or prior to receipt of the user's prompt; and
generate the enhanced prompt based on the user's prompt and the subject matter to which the user is paying attention at the time or prior to receipt of the user's prompt by generating the enhanced prompt based on the user's prompt and subject matter presented on the display to which the user is paying attention at the time or prior to receipt of the user's prompt.

16. A method performed by a computing device for generating a prompt for a generative artificial intelligence model (LXM), comprising:
receiving a user's prompt for the LXM;
determining a user's attention to subject matter at the time or prior to receipt of the user's prompt;
generating an enhanced prompt based on the user's prompt and the subject matter to which the user is paying attention at the time or prior to receipt of the user's prompt; and
submitting the enhanced prompt to the LXM.

17. The method of claim 16, wherein generating the enhanced prompt based on the user's prompt and the subject matter to which the user is paying attention comprises applying an adaptive important weighting to portions of the user's prompt based on the user's attention to the subject matter at the time or prior to receipt of the user's prompt.

18. The method of claim 16, wherein determining a user's attention to the subject matter comprises one or more of tracking the user's eye gaze on the subject matter, tracking a mouse cursor location on the subject matter, or tracking the user's touch locations on the subject matter.

19. The method of claim 16, wherein generating the enhanced prompt comprises generating a summary prompt that includes words assigned greater weight based on the user's attention to the subject matter at the time or prior to receipt of the user's prompt.

20. The method of claim 16, wherein applying an adaptive important weighting to portions of the user's prompt based on the user's attention to the subject matter at the time or prior to receipt of the user's prompt comprises adding an attention bias weight to words in the user's prompt based observations of the user's attention paid to words or phrases in the subject matter prior to entry of the user's prompt.

21. The method of claim 20, further comprising increasing the attention bias weight responsive to a duration the user focused on particular words and decreasing the attention bias weight with time after the user focus shifts away from the particular words.

22. The method of claim 21, wherein an amount by which the attention bias weight is increased responsive to the duration the user focused on the particular words and decreases with time after the user focus shifts away from the particular words depends on one or more of a type of word, a relevance of the words to the user's prompt, or a uniqueness of the words.

23. The method of claim 16, wherein generating the enhanced prompt based on the user's prompt and the subject matter to which the user is paying attention comprises including in the enhanced prompt information regarding the subject matter to which the user paid attention to at the time or prior to receipt of the user's prompt.

24. The method of claim 23, wherein including in the enhanced prompt information regarding the subject matter to which the user paid attention to at the time or prior to receipt of the user's prompt comprises:
generating text describing a portion of the subject matter to which the user paid attention to at the time or prior to receipt of the user's prompt; and
including at least a portion of the generated text in the enhanced prompt.

25. The method of claim 23, wherein including in the enhanced prompt information regarding the subject matter to which the user paid attention to at the time or prior to receipt of the user's prompt comprises:
generating text summarizing the subject matter to which the user paid attention to at the time or prior to receipt of the user's prompt; and
including at least a portion of the generated text in the enhanced prompt.

26. The method of claim 16, wherein determining the user's attention to the subject matter at the time or prior to receipt of the user's prompt comprises determining the user's attention to subject matter associated with the computing device at the time or prior to receipt of the user's prompt.

27. The method of claim 16, wherein determining the user's attention to the subject matter at the time or prior to receipt of the user's prompt comprises determining the user's attention to subject matter associated with another nearby device at the time or prior to receipt of the user's prompt.

28. The method of claim 16, wherein:
receiving the user's prompt for the LXM comprises receiving the user's prompt for a large language model (LLM); and
submitting the enhanced prompt to the LXM comprises submitting the enhanced prompt to the LLM.

29. The method of claim 16, wherein:
determining the user's attention to the subject matter at the time or prior to receipt of the user's prompt comprises determining the user's attention to subject matter presented on a display of the computing device at the time or prior to receipt of the user's prompt; and
generating the enhanced prompt based on the user's prompt and the subject matter to which the user is paying attention at the time or prior to receipt of the user's prompt comprises generating the enhanced prompt based on the user's prompt and subject matter presented on the display to which the user is paying attention at the time or prior to receipt of the user's prompt.

30. A computing device, comprising:
means for receiving a user's prompt for a generative artificial intelligence model (LXM);
means for determining a user's attention to subject matter at the time or prior to receipt of the user's prompt;
means for generating an enhanced prompt based on the user's prompt and the subject matter to which the user is paying attention at the time or prior to receipt of the user's prompt; and
means for submitting the enhanced prompt to the LXM.
